(19) United States
(12) Patent Application Publication
(10) Pub. No.: US 2026/0200005 A1
(43) Pub. Date: Jul. 16, 2026

(54) OFF-AXIS BAR FEEDING AND COAXIAL DEPOSITION FRICTION STIR ADDITIVE MANUFACTURING DEVICE AND METHOD

(71) Applicant: Harbin Institute of Technology, Harbin (CN)

(72) Inventors: Yongxian HUANG, Harbin (CN); Xiangchen MENG, Harbin (CN); Yuming XIE, Harbin (CN); Xuanmo LI, Harbin (CN); Xiaotian MA, Harbin (CN); Naijie WANG, Harbin (CN)

(73) Assignee: Harbin Institute of Technology, Harbin (CN)

(21) Appl. No.: 19/444,117

(22) Filed: Jan. 8, 2026

(30) Foreign Application Priority Data
Jan. 16, 2025 (CN) 202510067240.1

(51) Int. Cl. B23K 20/12; B33Y 10/00; B33Y 30/00

(52) U.S. Cl. CPC B23K 20/1215; B23K 20/1245; B33Y 10/00; B33Y 30/00

(57) ABSTRACT

The present disclosure relates to an off-axis bar feeding and coaxial deposition friction stir additive manufacturing (FSAM) device and method, and belongs to the technical field of additive manufacturing. The off-axis bar feeding and coaxial deposition FSAM device includes an additive mechanism, a bar feeding mechanism, a material loading mechanism, and a support mechanism, where the bar feeding mechanism and the material loading mechanism are both connected to the additive mechanism through the support mechanism. The off-axis continuous bar feeding device of the present disclosure enables off-axis continuous feeding of bar materials and synchronized coaxial deposition for solid-phase additive manufacturing, reduces a large axial force required by conventional coaxial bar feeding FSAM, and solves the problem of a difficulty in achieving continuous material feeding in coaxial bar feeding additive manufacturing.

### RELATED APPLICATIONS

This application claims the benefit of priority of Chinese application number 202510067240.1, filed on January 16, 2025. The entire contents of the above-mentioned applications are incorporated herein by reference.

### TECHNICAL FIELD

The present disclosure relates to an additive manufacturing device and method, and belongs to the technical field of additive manufacturing.

### BACKGROUND

Friction stir additive manufacturing (FSAM), as a solid-phase additive manufacturing method involving low temperature and severe plastic deformation, may eliminate defects such as porosity, cracking, and element loss that occur in the melting and solidification processes of a conventional fusion-based additive manufacturing method. With the advantages such as fine grain structures, dispersed distribution of precipitates, dense interfacial bonding, low residual stress, controllable shapes and properties, and high mechanical performance, the FSAM exhibits a significant potential for the integrated manufacturing of monolithic structural components made from lightweight materials such as aluminum alloys and magnesium alloys.

Currently, mainstream FSAM technologies are classified into four categories by forms of raw materials: sheet-based, bar-based, powder-based, and wire-based. According to existing literature reports, the sheet-based, bar-based, and powder-based modes have a relatively wide range of material applicability. However, in the material feeding and deposition processes, these modes encounter problems such as a difficulty in continuous material feeding, a large forming width, a low material utilization rate, and a large axial force required for equipment, as described in Reference Documents CN105171229A and CN117161406A. A wire, as a bendable and coilable material, is an ideal material capable of achieving continuous feeding and has the conditions for enabling continuous additive manufacturing of large components, as described in disclosed patents such as CN115647569A and CN115502544A. Various wires of aluminum alloys or magnesium alloys with good toughness have been successfully prepared, and processed into forms such as a spool wire or a drum wire. Nevertheless, some challenges remain unresolved in the wire-based FSAM: Firstly, a material with poor plasticity is difficultly prepared into a corresponding wire through deformation, which limits the application scope of friction stir solid-state additive manufacturing; secondly, in the additive manufacturing process, the wire is prone to thermal softening and deformation, leading to feeding instability; and thirdly, a diameter of the wire is relatively small, and a wire feeding rate must match a rotational speed of a screw to achieve continuous material shearing, resulting in a limited material volume fed into an additive device per unit time and a difficulty in significant improvement of deposition efficiency.

Therefore, there is an urgent need to propose an off-axis bar feeding and coaxial deposition FSAM device and method to solve the above technical problems.

### SUMMARY

In order to solve the above problems, an off-axis bar feeding and coaxial deposition FSAM device and method are provided. A brief summary of the present disclosure is given below to provide a basic understanding of certain aspects of the present disclosure. It should be understood that this summary is not an exhaustive overview of the present disclosure. It is not intended to identify key or important elements of the present disclosure, nor is it intended to limit the scope of the present disclosure.

### The technical solution of the present disclosure is as follows:

An off-axis bar feeding and coaxial deposition FSAM device includes an additive mechanism, a bar feeding mechanism, a material loading mechanism, and a support mechanism, where the bar feeding mechanism and the material loading mechanism are both connected to the additive mechanism through the support mechanism.

Preferably, the additive mechanism includes a screw and a sleeve, where the screw is located in the sleeve, and the screw is coaxially arranged with the sleeve.

Preferably, an upper portion of the screw is a screw clamping portion, a helical groove is machined on a side surface of a lower portion of the screw, and a stirring pin is machined at a bottom end of the screw; and

an upper side of the sleeve is a sleeve clamping portion, a lower end of the sleeve is a sleeve bottom surface, a feeding hole is machined in a side surface of the sleeve, the helical groove of the screw is located in the sleeve, and the stirring pin extends from the lower end of the sleeve.

Preferably, the bar feeding mechanism includes a stepper motor, a bar feeder backplate, a motor gear, bar feeding wheel gears, bar feeding wheels, limiting tubes, and spring compression structures, where the motor gear and the bar feeding wheel gears on a side are mounted on the bar feeder backplate, the stepper motor is mounted on the bar feeder backplate, the motor gear is connected to an output end of the stepper motor, the motor gear meshes with the bar feeding wheel gears on one side, the bar feeding wheel gears on the other side are connected to the spring compression structures, the bar feeding wheel gears on both sides mesh with each other to form a bar feeding gear set, the bar feeding wheel gears are coaxially connected to the bar feeding wheels, the spring compression structures are connected to the bar feeder backplate, and the limiting tubes are disposed at front and rear ends of the bar feeder backplate.

Preferably, the bar feeding mechanism further includes bolts, where the bar feeding wheel gears and the bar feeding wheels are connected by the bolts, the two bar feeding wheels are arranged correspondingly, the two bar feeding gear sets are arranged on both sides of the motor gear, the limiting tubes are arranged on both sides of the two bar feeding gear sets, and the limiting tube on an output side is arranged corresponding to the feeding hole;

the bar feeding mechanism further includes limiting tube brackets, each limiting tube is provided with a bell mouth, the limiting tubes are detachably connected to the bar feeding mechanism through the limiting tube brackets, and the limiting tubes are arranged corresponding to a position between the two bar feeding wheels;

a V-groove matching a diameter of a bar material is machined in a middle portion of a side surface of each bar feeding wheel, with a taper angle ranging from 10° to 45°, and configured to achieve automatic centering of the rod material between the two bar feeding wheels; and wheel side recesses are laser-etched in a side surface of each bar feeding wheel, and configured to increase a friction between the bar feeding wheel and the conveyed rod material and prevent slippage in a bar feeding process; and

each spring compression structure includes a compression frame, a spring, a compression nut, and a slide rod, where the two compression frames are hinged at one end, and each compression frame is provided with a U-shaped slide groove at the other end; the T-shaped slide rod is fixed to the bar feeder backplate, a vertical segment of the slide rod is connected to the bar feeder backplate, the spring is sleeved over a horizontal segment of the slide rod, and an end of the horizontal segment of the slide rod is threadedly connected to the compression nut; and the horizontal segment of the slide rod is disposed in the U-shaped slide groove of the compression frame, the U-shaped slide groove of the compression frame is located between the vertical segment of the slide rod and the spring, and the bar feeding wheel gear and the corresponding bar feeding wheel on the other side are connected to a middle portion of the compression frame.

Preferably, the material loading mechanism includes a backplate, a V-groove, cover plates, a base plate, a guide shaft, a push block, a cylinder, a photoelectric sensor, and a limiting hole, where the cover plates are mounted on both sides of the backplate, the base plate is mounted at a lower portion of the backplate, and the V-groove and the cylinder are mounted on the base plate; and the guide shaft is mounted on a front side of the base plate, and the photoelectric sensor and the limiting hole arranged front-to-back are mounted on a rear side of the base plate; and an output end of the cylinder is connected to the push block, the push block is slidably connected to the guide shaft, an end of the push block cooperates with the V-groove, and the cylinder is electrically connected to the photoelectric sensor.

Preferably, the material loading mechanism further includes guide shaft brackets and a cylinder rod, where the cylinder is connected to the push block through the cylinder rod, and both ends of the guide shaft are connected to the base plate through the guide shaft brackets; and

the photoelectric sensor includes a sensor bracket, a transmitter, and a receiver, a sensor bracket mounting hole is machined in the base plate, and a light transmission hole is machined in the backplate; the sensor bracket is M-shaped, a screw rod and nuts are disposed on a middle vertical plate of the sensor bracket, the screw rod passes through the sensor bracket mounting hole, and after a position of the screw rod is adjusted, the nuts on both sides of the screw rod are tightened to clamp the base plate, so as to fix the sensor bracket; a vertical plate of the sensor bracket on one side is located on a left side of the light transmission hole, the receiver is mounted on the vertical plate of the sensor bracket on one side, a vertical plate of the sensor bracket on the other side is located on a right side of the light transmission hole, and the transmitter is mounted on the vertical plate of the sensor bracket on the other side; and the limiting tube on an input side is arranged corresponding to the limiting hole.

Preferably, the support mechanism includes a mounting disc, a rotating shoulder tool holder, a stationary shoulder bracket, a stationary shoulder bracket end cover, first bar feeder brackets, second bar feeder brackets, third bar feeder brackets, a channel steel crossbeam, aluminum profile brackets, and a tie rod, where the screw clamping portion of the screw is connected to the rotating shoulder tool holder, the sleeve clamping portion of the sleeve is located between the stationary shoulder bracket and the stationary shoulder bracket end cover, the rotating shoulder tool holder is rotatably connected coaxially to the mounting disc and the stationary shoulder bracket located above and below, and the mounting disc is relatively fixed to the stationary shoulder bracket; a front end of the bar feeder backplate is connected to the third bar feeder bracket through bolts, the two second bar feeder brackets are symmetrically arranged on outer sides of the third bar feeder brackets, an upper end of each second bar feeder bracket is connected to the corresponding first bar feeder bracket, and a rear end of each first bar feeder bracket is fixedly connected to the mounting disc; a first rectangular hole is machined in each first bar feeder bracket, two parallel second rectangular mounting holes are machined in each second bar feeder bracket, a threaded hole is machined in a top end of each second bar feeder bracket, and a third rectangular mounting hole is machined in each third bar feeder bracket; the third bar feeder brackets are adjusted to a suitable position, third bolts are passed through the second rectangular mounting holes and the third rectangular mounting holes and tightened with third nuts to fix the third bar feeder brackets and the second bar feeder brackets, and second bolts are passed through the first rectangular holes and connected to the threaded holes of the second bar feeder brackets to fix the second bar feeder brackets to the first bar feeder brackets; and the channel steel crossbeam is connected to the backplate of the material loading mechanism through a plurality of the aluminum profile brackets, a rear portion of the channel steel crossbeam is rotatably connected to the first bar feeder bracket, and both ends of the tie rod arranged obliquely are hinged to a middle portion of the channel steel crossbeam and an upper portion of the mounting disc, respectively.

Preferably, the tie rod includes hinge seats, tie rod arms, and a connecting stud, where both ends of the connecting stud are threadedly connected to one end of each tie rod arm, respectively, each hinge seat is disposed at the other end of each tie rod arm, and the two hinge seats are detachably connected to the channel steel crossbeam and the mounting disc through bolts, respectively.

An off-axis bar feeding and coaxial deposition FSAM method employs an off-axis bar feeding and coaxial deposition FSAM device, and includes the following steps:

positions of a bar feeding mechanism and a material loading mechanism are adjusted through a support mechanism to adapt to an additive mechanism; and when the additive mechanism moves horizontally or vertically, the relative positions remain unchanged to ensure smooth material conveying;

to-be-conveyed bar materials are arranged individually along a vertical direction, the bottommost to-be-conveyed bar material is discharged downward by gravity to become a currently conveyed bar material, and the currently conveyed bar material rests on a V-groove;

a photoelectric sensor detects the currently conveyed bar material and controls a cylinder rod to retract, and a push block is driven to push a front end of the currently conveyed bar material into a limiting tube on one side through a limiting hole along the V-groove;

the front end of the currently conveyed bar material is conveyed between bar feeding wheels, a motor gear drives bar feeding wheel gears on one side, and the bar feeding wheel gears on one side in turn drive bar feeding wheel gears and bar feeding wheels on the other side to rotate, such that the currently conveyed bar material is conveyed into a limiting tube on the other side;

after a rear end of the currently conveyed bar material moves away from the photoelectric sensor, the photoelectric sensor controls the cylinder rod to extend, and the push block is driven to return; after the push block return to an initial position, the next to-be-conveyed bar material, no longer obstructed by the push rod, descends by gravity into the V-groove, the photoelectric sensor detects the subsequent currently conveyed bar material, and the material conveying process continues; and

the front end of the currently conveyed bar material is conveyed into the additive mechanism through a feeding hole, is sheared and plasticized, and is then extruded from a lower portion of a sleeve onto a substrate, a stirring pin stirs the material, and a sleeve bottom surface levels the material, such that the additive manufacturing is completed.

### The present disclosure has the following beneficial effects:

1 The off-axis continuous bar feeding device of the present disclosure enables off-axis continuous feeding of bar materials and synchronized coaxial deposition for solid-phase additive manufacturing, reduces a large axial force required by conventional coaxial bar feeding FSAM, and solves the problem of a difficulty in achieving continuous material feeding in coaxial bar feeding additive manufacturing.

2 The bar material used in the present disclosure has a larger diameter and higher stiffness, thereby effectively preventing stiffness reduction caused by thermal softening deformation of the additive manufacturing stock, and solving the problem of feeding port clogging common in conventional FSAM methods.

3 In the off-axis bar feeding process of the present disclosure, alternating feeding and deposition of bar materials with different materials, different compositions, or different volume fractions of reinforcement phases may be achieved, and high-performance, large-sized components with changing microstructural gradients or strength-toughness alternating variations may be manufactured.

4 The bar material used in the present disclosure has a larger diameter. At the same feeding rate, a greater volume of stock is delivered into the additive mechanism, and the resulting material particles are larger in size, thereby facilitating enhancement of heat generation and plastic flow in the additive device, and significantly improving deposition efficiency.

5 The bar material used in the present disclosure has a wider range of sources, exhibits low processing costs, and is applicable to alloy materials with poor plasticity that are difficult to process into wire materials, such as rare-earth magnesium alloys and high-volume-fraction aluminum matrix composites.

### BRIEF DESCRIPTION OF THE DRAWINGS

FIG. 1 is a schematic structural view of an off-axis bar feeding and coaxial deposition FSAM device according to the present disclosure.

FIG. 2 is a schematic partial view of an off-axis bar feeding and coaxial deposition FSAM device according to the present disclosure.

FIG. 3 is a schematic sectional view of an additive mechanism according to the present disclosure.

FIG. 4 is a schematic structural view of a bar feeding mechanism according to the present disclosure.

FIG. 5 is a schematic structural view of a material loading mechanism according to the present disclosure.

FIG. 6 is a partial left view of a material loading mechanism according to according to the present disclosure.

FIG. 7 is a partial enlarged view showing a position of a photoelectric sensor in a material loading mechanism according to the present disclosure.

FIG. 8 is a schematic structural view of a support mechanism according to the present disclosure.

Reference numerals in the figures: 1-additive mechanism; 2-bar feeding mechanism; 3-material loading mechanism; 4-support mechanism; 10-currently conveyed bar material; 100-to-be-conveyed bar material; 11-screw; 110-stirring pin; 111-helical groove; 112-screw clamping portion; 12-sleeve; 120-feeding hole; 121-sleeve bottom surface; 122-sleeve clamping portion; 20-stepper motor; 21-bar feeder backplate; 22-motor gear; 23-bar feeding wheel gear; 24-bar feeding wheel; 240-assembling bolt; 241-V-groove; 242-wheel side recess; 25-limiting tube; 250-bell mouth; 251-limiting tube bracket; 26-spring compression structure; 260-compression frame; 261-spring; 262-compression nut; 263-slide rod; 264-U-shaped slide groove; 30-backplate; 300-sensor bracket mounting hole; 301-light transmission hole; 31-V-groove; 32-cover plate; 33-base plate; 34-guide shaft; 340-guide shaft bracket; 35-push block; 36-cylinder; 360-cylinder rod; 37-photoelectric sensor; 370-sensor bracket; 371-transmitter; 372-receiver; 38-limiting hole; 40-mounting disc; 41-rotating shoulder tool holder; 42-stationary shoulder bracket; 43-stationary shoulder bracket end cover; 44-first bar feeder bracket; 45-second bar feeder bracket; 46-third bar feeder bracket; 47-channel steel crossbeam; 48-aluminum profile bracket; 49-tie rod; 490-hinge seat; 491-tie rod arm; and 492-connecting stud.

### DETAILED DESCRIPTIONS OF THE EMBODIMENTS

To make the objective, technical solution, and advantages of the present disclosure clearer, the present disclosure is described below through specific embodiments illustrated in the drawings. It should be understood, however, that these descriptions are merely exemplary and are not intended to limit the scope of the present disclosure. Moreover, in the following description, descriptions of well-known structures and techniques are omitted to avoid unnecessarily obscuring the concepts of the present disclosure.

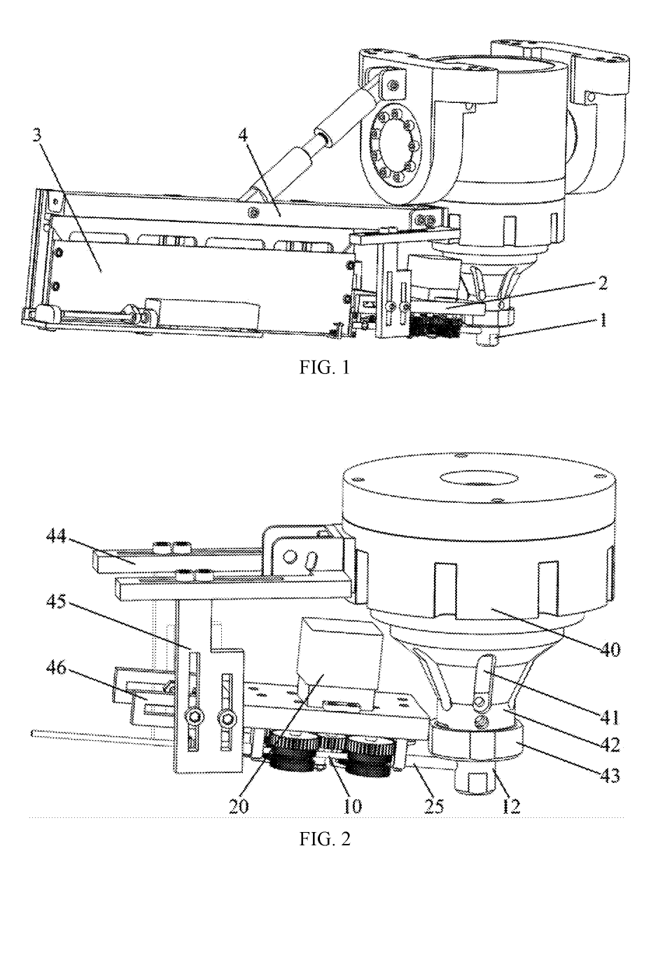

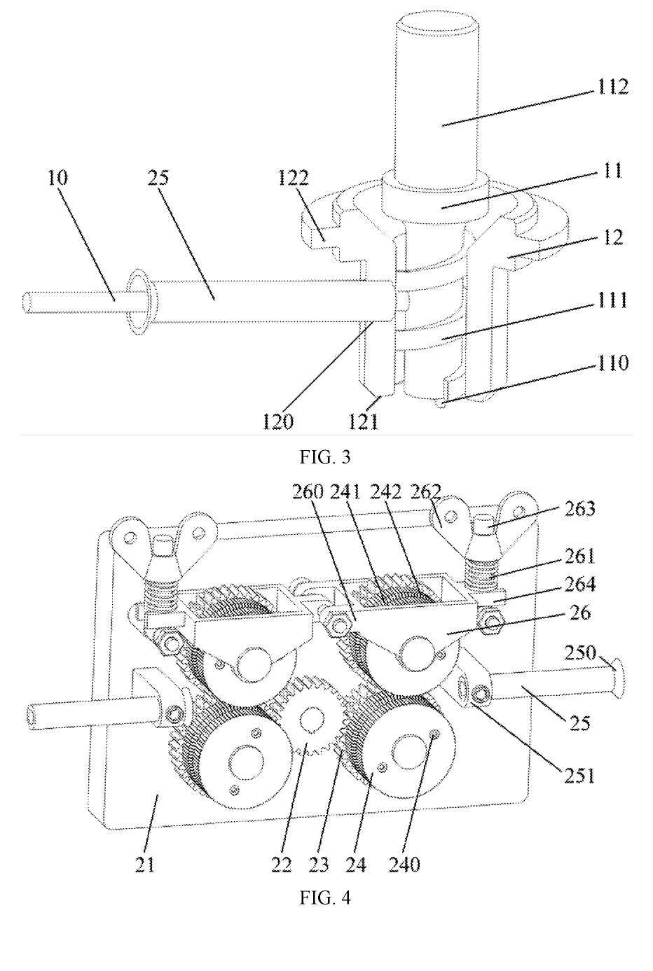

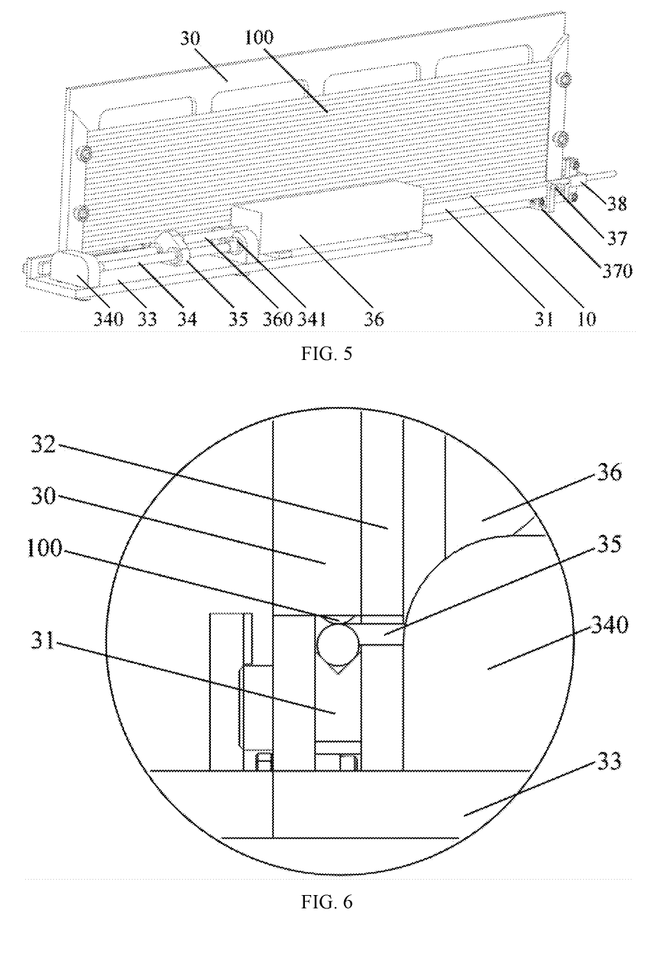

Specific Embodiment 1: This embodiment is described with reference to FIGS. 1 to 8. An off-axis bar feeding and coaxial deposition FSAM device according to this embodiment includes an additive mechanism 1, a bar feeding mechanism 2, a material loading mechanism 3, and a support mechanism 4, where the bar feeding mechanism 2 and the material loading mechanism 3 are both connected to the additive mechanism 1 through the support mechanism 4. The material loading mechanism 3 is configured to store bar materials and sequentially and continuously discharge the individual bar materials; the bar feeding mechanism 2 is configured to receive the bar materials discharged from the material loading mechanism 3 and convey the bar materials to the additive mechanism 1; and the additive mechanism 1 is configured to shear the bar materials into small particles, convey the particles along a helical groove to a bottom, and form a dense deposition layer under the action of a stirring pin and a sleeve bottom surface.

The additive mechanism 1 includes a screw 11 and a sleeve 12, where the screw 11 is located in the sleeve 12, and the screw 11 is coaxially arranged with the sleeve 12; the sleeve 12 is of a hollow structure, an inner wall thereof and a helical groove 111 of the screw cooperatively enclose a helical cavity, and a feeding hole 120 is formed in a side wall of the sleeve 12, is communicated with the cavity, and is configured to feed the bar material (the currently conveyed bar material 10) into the cavity.

An upper portion of the screw 11 is a screw clamping portion 112, the helical groove 111 is machined on a side surface of a lower portion of the screw 11, and a stirring pin 110 is machined at a bottom end of the screw 11.

An upper side of the sleeve 12 is a sleeve clamping portion 122, a lower end of the sleeve 12 is a sleeve bottom surface 121, the feeding hole 120 is machined in a side surface of the sleeve 12, the helical groove 111 of the screw 11 is located in the sleeve 12, and the stirring pin 110 extends from the lower end of the sleeve 12.

Specifically, during an additive test, the screw 11 rotates at a high speed, and the stirring pin 110 at a bottom of the screw 11 plunges into a substrate. After reaching a predetermined depth, a stepper motor 20 of the bar feeding mechanism 2 is activated. The bar material 10 is fed into the additive mechanism 1 through the feeding hole 120, and is sheared by the screw 11 into block-shaped particles, and the particles are conveyed along the helical groove 111 to a bottom of the additive mechanism 1, and are extruded therefrom. The particles are mixed with a substrate material under a stirring action of the stirring pin 110 and form a dense deposition layer under a forging action of a sleeve bottom surface 121.

The bar feeding mechanism 2 includes a stepper motor 20, a bar feeder backplate 21, a motor gear 22, bar feeding wheel gears 23, bar feeding wheels 24, limiting tubes 25, and spring compression structures 26, where the motor gear 21 and the bar feeding wheel gears 23 on an side are mounted on the bar feeder backplate 21 through rotating shafts, the stepper motor 20 is mounted on the bar feeder backplate 21 through bolts, the motor gear 22 is connected to an output end of the stepper motor 20, the motor gear 22 meshes with the bar feeding wheel gears 23 on one side, the bar feeding wheel gears 23 on the other side are connected to the spring compression structures 26 through rotating shafts, the bar feeding wheel gears 23 on both sides mesh with each other to form a bar feeding gear set, each bar feeding wheel gear 23 is coaxially connected correspondingly to one bar feeding wheel 24, the spring compression structures 26 are connected to the bar feeder backplate 21, and the limiting tubes 25 are disposed at front and rear ends of the bar feeder backplate 21.

The bar feeding mechanism 2 further includes bolts 240, where the bar feeding wheel gears 23 and the bar feeding wheels 24 are connected by the bolts 240, the two bar feeding wheels 24 are arranged correspondingly left and right, the two bar feeding gear sets are symmetrically arranged on front and rear sides of the motor gear 22, and the limiting tubes 25 are arranged on front and rear sides of the two bar feeding gear sets; and the limiting tube 25 on an output side is arranged corresponding to and connected to the feeding hole 120;

The bar feeding mechanism 2 further includes limiting tube brackets 251, and an input end of each limiting tube 25 is provided with a bell mouth 250 to facilitate feeding; and the limiting tubes 25 are detachably connected to the bar feeding mechanism 2 by being inserted into through holes of the limiting tube brackets 251 and tightened and fixed by screws, the limiting tube brackets 251 are welded to the bar feeding mechanism 2, and the limiting tubes 25 are arranged corresponding to a position between the two corresponding left and right bar feeding wheels 24.

A V-groove 241 is machined in a side surface of each bar feeding wheel 24, and configured to achieve automatic centering of the rod material between the two bar feeding wheels 24; and wheel side recesses 242 are laser-etched in a side surface of each bar feeding wheel 24, and configured to increase a friction between the bar feeding wheel 24 and the rod material 10 and prevent slippage in a bar feeding process.

Each spring compression structure 26 includes a compression frame 260, a spring 261, a compression nut 262, and a slide rod 263, where the two compression frames 260 are hinged to each other at one end, and each compression frame 260 is provided with a U-shaped slide groove 264 at the other end; the T-shaped slide rod 263 is fixed to the bar feeder backplate 21, a vertical segment of the slide rod 263 is connected to the bar feeder backplate 21, the spring 261 is sleeved over a horizontal segment of the slide rod 263, and an end of the horizontal segment of the slide rod 263 is threadedly connected to the compression nut 262; the horizontal segment of the slide rod 263 is disposed in the U-shaped slide groove of the compression frame 260, the U-shaped slide groove of the compression frame 260 is located between the vertical segment of the slide rod 263 and the spring 261, and the bar feeding wheel gear 23 and the bar feeding wheel 24 on the other side are connected to a middle portion of the compression frame 260 through rotating shafts; and by rotating the compression nut 262, a force exerted by the spring 261 on the compression frame 260 is changed to achieve compression adjustment and provide good adaptability.

Specifically, in the bar feeding mechanism 2, the stepper motor 20 is connected to the motor gear 22 through a parallel key, and the motor gear 22 meshes with the bar feeding wheel gears 23; simultaneously, the upper and lower bar feeding wheel gears 23 in FIG. 4 mesh with each other, the bar feeding wheels 24 are mounted on the bar feeding wheel gears 23 through the bolts 240, and in this way, the stepper motor 20 is capable of driving the bar feeding wheels 24 on both sides to rotate synchronously; a V-groove 241 is machined in each bar feeding wheel 24 to achieve automatic centering of the bar material, and wheel side recesses are machined in a working surface of each bar feeding wheel to increase a friction and prevent slippage in the feeding process; a spacing between the bar feeding wheels 24 on both sides is adjusted by the spring compression structure 26 to ensure that the bar feeding wheels 24 exert a sufficient clamping force on the bar material 10; and limiting tubes 25 are mounted at front and rear ends of the bar feeding mechanism, respectively, and configured to prevent the deformed bar material from deviating from a predetermined trajectory.

The material loading mechanism 3 includes a backplate 30, a V-groove 31, cover plates 32, a base plate 33, a guide shaft 34, a push block 35, a cylinder 36, a photoelectric sensor 37, and a limiting hole 38, where the cover plates 32 are mounted on both sides of the backplate 30, the base plate 33 is mounted at a lower portion of the backplate 30, to-be-conveyed bar materials 100 are stacked in a gap between the backplate 30 and the cover plates 32, a V-groove 31 is formed below the gap between the backplate 30 and the cover plates 32, and a distance between the V-groove 31 and the cover plates 32 allows a single currently conveyed bar material 10 to pass through; after the currently conveyed bar material 10 is conveyed out, the bottommost to-be-conveyed bar material 100 falls into the V-groove 31 by gravity to become the subsequent currently conveyed bar material 10; the V-groove 31 and the cylinder 36 are mounted on the base plate 33, the guide shaft 34 is mounted on a front side of the base plate 33, the photoelectric sensor 37 and the limiting hole 38 arranged front-to-back are mounted on a rear side of the base plate 33, the photoelectric sensor 37 is located beside the currently conveyed bar material 10, and the limiting hole 38 is located at a front end of the material loading mechanism 3; and an output end of the cylinder 36 is connected to the push block 35, the push block 35 is slidably connected to the guide shaft 34, an end of the push block 35 cooperates with the currently conveyed bar material 10 on the V-groove 31, and the cylinder 36 is electrically connected to the photoelectric sensor 37.

The material loading mechanism 3 further includes guide shaft brackets 340 and a cylinder rod 360, where the cylinder 36 is connected to the push block 35 through the cylinder rod 360, and both ends of the guide shaft 34 are connected to the base plate 33 through the guide shaft brackets 340.

The photoelectric sensor 37 includes a sensor bracket 370, a transmitter 371, and a receiver 372, a sensor bracket mounting hole 300 is machined in the base plate 33, and a light transmission hole 301 is machined in a position of the backplate 30 corresponding to the currently conveyed bar material 10; the sensor bracket 370 is M-shaped, a screw rod and nuts are disposed on a middle vertical plate of the sensor bracket 370, the screw rod passes through the sensor bracket mounting hole 300, and after a position of the screw rod is adjusted, the nuts on both sides of the screw rod are tightened to clamp the base plate 33, so as to fix the sensor bracket 370; a vertical plate of the sensor bracket 370 on one side is located on a left side of the light transmission hole 301 and the V-groove 31, the receiver 372 is mounted on the vertical plate of the sensor bracket 370 on one side, a vertical plate of the sensor bracket 370 on the other side is located on a right side of the light transmission hole 301 and the V-groove 31, the transmitter 371 is mounted on the vertical plate of the sensor bracket 370 on the other side, and the light transmission hole 301 prevents obstruction between the transmitter 371 and the receiver 372; and the limiting tube 25 on an input side is arranged corresponding to the limiting hole 38.

Specifically, in the material loading process, a bar material falls from a magazine into the V-groove 31 and obstructs the light transmission hole 301 at the end of the mechanism, the photoelectric sensor 37 cannot receive a light signal and sends a signal to the cylinder 36 to retract, and the push block 35 is controlled to push out a single bar material 10. When the push block 35 moves to a limit of the guide shaft bracket 340 and cannot continue moving, the bar material 10 has already been fed into the bar feeding mechanism 2 and is clamped and continuously conveyed by the bar feeding wheels 24, and the stationary push block 35 and the currently conveyed bar material 10 together play a role of supporting the remaining bar materials 100. When the currently conveyed bar material 10 passes the light transmission hole 301, the photoelectric sensor 37 detects light and sends a signal to the cylinder 36 to extend, and the push block 35 is controlled to move out of a range of a magazine bottom. At this moment, the currently conveyed bar material 10 is just moved out of the range of the magazine bottom, the remaining bar materials 100 in the magazine fall down, the bottommost bar material obstructs the light transmission hole 301, and the cylinder is controlled again to retract and push out a single bar material, thereby achieving continuous material loading.

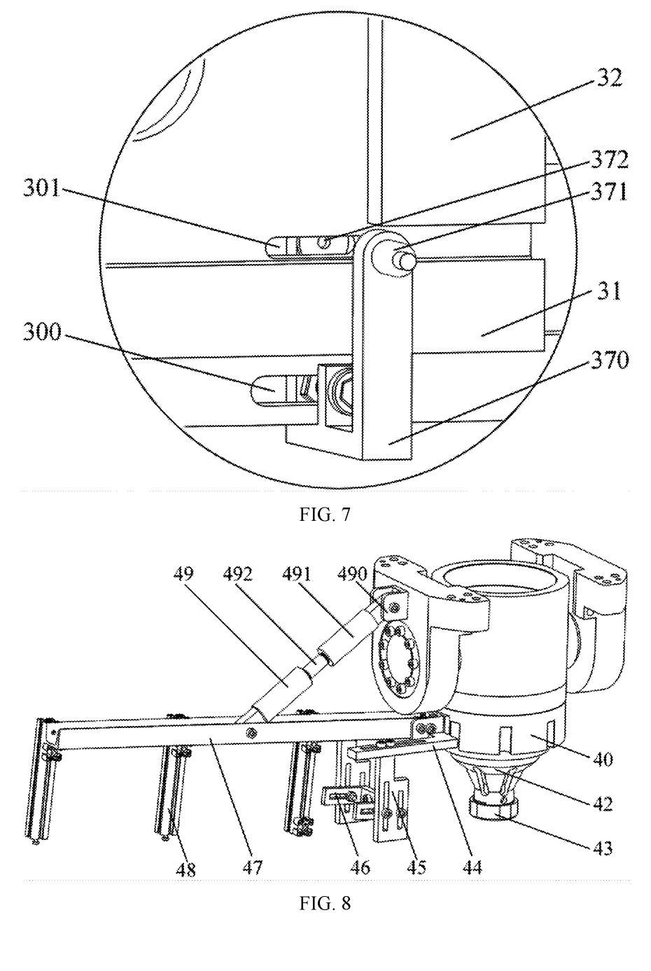

Specifically, the magazine of the material loading mechanism 3 is enclosed by the backplate 30 and the cover plates 32, and is configured to arrange the bar materials individually along a vertical direction and achieve downward discharging by gravity; the V-groove 31 is mounted on the backplate 30, and a mounting relationship as shown in FIG. 7 is maintained, such that after a single bar material 10 is discharged into the V-groove 31, a lateral space is insufficient for the remaining bars 100 to fall down; the cylinder 36 is connected to the push block 35 through the cylinder rod 360 and is limited by the guide shaft 34, such that the push block may move between the two guide shaft brackets 340; and the extension and retraction of the cylinder rod 360 are controlled by the photoelectric sensor 37, a position thereof may be adjusted through the sensor bracket mounting hole 300 in the backplate, the receiver 372 detecting light corresponds to an extension state, and the receiver 372 not detecting light corresponds to a retraction state. The limiting hole 38 is formed at the end of the material loading mechanism to constrain a movement trajectory of the bar material.

The support mechanism 4 includes a mounting disc 40, a rotating shoulder tool holder 41, a stationary shoulder bracket 42, a stationary shoulder bracket end cover 43, first bar feeder brackets 44, second bar feeder brackets 45, third bar feeder brackets 46, a channel steel crossbeam 47, aluminum profile brackets 48, and a tie rod 49, wherein the screw clamping portion 112 of the screw 11 is connected to the rotating shoulder tool holder 41, the sleeve clamping portion 122 of the sleeve 12 is located, clamped, and fixed between the stationary shoulder bracket 42 and the stationary shoulder bracket end cover 43, the rotating shoulder tool holder 41 is rotatably connected coaxially to the mounting disc 40 and the stationary shoulder bracket 42 located above and below, and the mounting disc 40 is relatively fixed to the stationary shoulder bracket 42; the two third bar feeder brackets 46 are disposed at a front end of the bar feeder backplate 21, the two second bar feeder brackets 45 are symmetrically arranged on outer sides of the two third bar feeder brackets 46, an upper end of each second bar feeder bracket 45 is connected to the corresponding first bar feeder bracket 44 arranged horizontally, a mounting plate is disposed at a rear end of each first bar feeder bracket 44, and a rear end of each first bar feeder bracket 44 is fixedly connected to the mounting disc 40; a first rectangular hole is machined in each first bar feeder bracket 44, two parallel second rectangular mounting holes are machined in each vertical second bar feeder bracket 45, a threaded hole is machined in a top end of each second bar feeder bracket 45, and a third rectangular mounting hole is machined in each third bar feeder bracket 46; the third bar feeder brackets 46 are adjusted to a suitable position, third bolts are passed through the second rectangular mounting holes and the third rectangular mounting holes and tightened with third nuts to fix the third bar feeder brackets 46 and the second bar feeder brackets 45, second bolts are passed through the first rectangular holes and connected to the threaded holes of the second bar feeder brackets 45 to fix the second bar feeder brackets 45 to the first bar feeder brackets 44, and adjustment to a horizontal direction, a vertical direction, and various angles of inclination may be achieved; and the channel steel crossbeam 47 is connected to the backplate 30 of the material loading mechanism 3 through a plurality of the aluminum profile brackets 48, a rear portion of the channel steel crossbeam 47 is rotatably connected to the mounting plate at a rear end of the first bar feeder bracket 44, the mounting plate is provided with an arc-shaped slide groove, a rear end of the channel steel crossbeam 47 is provided with a cylindrical slider, the cylindrical slider is disposed in the arc-shaped slide groove, and both ends of the tie rod 49 arranged obliquely are hinged to a middle portion of the channel steel crossbeam 47 and an upper portion of the mounting disc 40, respectively.

The tie rod 49 includes hinge seats 490, tie rod arms 491, and a connecting stud 492, where both ends of the connecting stud 492 are threadedly connected to one end of each tie rod arm 491, respectively, each hinge seat 490 is disposed at the other end of each tie rod arm 491, the two hinge seats 490 are detachably connected to the channel steel crossbeam 47 and the mounting disc 40 through bolts, respectively. By rotating the connecting stud 492, an overall length of the tie rod 49 is adjusted to adjust a feeding angle. Moreover, the angle is limited under the limitation action of the arc-shaped slide groove, and the risk of collapse in case of tie rod failure is prevented, personnel safety is ensured, and the operation is simple and convenient.

Specifically, the screw 11 and the sleeve 12 of the additive mechanism 1 are mounted on a friction stir welding machine through the rotating shoulder tool holder 41 and the stationary shoulder bracket 42 of the support mechanism 4, respectively, with good coaxiality maintained; the bar feeding mechanism 2 is mounted on the stationary shoulder bracket 42 through the bar feeder brackets 44-46, and a mounting height and angle of the bar feeding mechanism 2 may be adjusted through bolts; and the material loading mechanism 3 is mounted on the channel steel crossbeam 47 and the aluminum profile brackets 48, and a mounting height and angle of the material loading mechanism 3 may be adjusted through the tie rod 49.

The present disclosure solves the problems of FSAM technologies in the prior art, such as a difficulty in continuous material feeding, low deposition efficiency, and narrow material applicability, and simultaneously provides technical advantages including continuous material feeding, high deposition efficiency, and broad material applicability, with a significant engineering application value.

Specific Embodiment 2: This embodiment is described with reference to FIGS. 1 to 8. An off-axis bar feeding and coaxial deposition FSAM method according to this embodiment employs the described off-axis bar feeding and coaxial deposition FSAM device which includes an additive mechanism, a bar feeding mechanism, a material loading mechanism, and a support mechanism. The additive mechanism mainly includes a screw and a sleeve, where the screw is configured to rotate about an own axis, is provided with a helical groove on a side surface, and is provided with a stirring pin on a bottom surface; the sleeve is of a hollow structure, an inner wall thereof and the helical groove of the screw cooperatively enclose a helical cavity, and a feeding hole is formed in a side wall of the sleeve, and is configured to feed a bar material into the cavity. The bar feeding mechanism employs a stepper motor to control synchronous rotation of bar feeding wheels on both sides via gear transmission, uses spring compression structures to control a spacing between the bar feeding wheels on both sides to clamp and convey the bar material, and enables stable feeding of the bar material into the feeding hole of the sleeve. The material loading mechanism adopts a "magazine" structure, the bar material falls from the magazine into a V-groove below and obstructs a light transmission hole of a photoelectric sensor near a discharge port, the sensor sends a signal to drive a cylinder to retract, a single bar material is pushed out, and the bar material moves between the bar feeding wheels and is then clamped and continuously conveyed by the bar feeding wheels; and when this bar material moves out of a magazine range, the photoelectric sensor detects light and sends a signal to the cylinder, the cylinder is driven to push the push block out of the magazine range, and the next bar material falls down, thereby achieving continuous loading. The support mechanism plays a role of mounting and support, such that other mechanisms may be mounted onto the friction stir welding machine, and a bar feeding angle is adjusted through the tie rod.

In an additive process, a bar material falls from the magazine in the material loading mechanism into the V-groove, is pushed by the cylinder-driven push block into the bar feeding mechanism, is then clamped by the bar feeding wheels and conveyed into the additive mechanism via the feeding hole of the sleeve, and is sheared by a helical groove of the screw to form block-shaped particles, and the particles move along the helical cavity toward a bottom of the screw. During conveying, the particles are deformed and generate heat due to extrusion and friction from the screw and a sleeve wall, and thus are plasticized. Finally, the plasticized material is extruded from a gap between the screw and a bottom of the sleeve, is mixed with a substrate or a previously deposited layer under the action of a stirring pin, and forms a dense deposition layer under a forging action of a sleeve bottom surface.

### The method includes the following steps:

Step 1, a bar material with a suitable diameter is selected according to different material, dimension, and performance requirements of an additively manufactured component, various dimensions of a screw 11 and a sleeve 12 are designed to ensure the bar material is capable of entering a helical cavity via a feeding hole 120 and being sheared into appropriately sized material particles by relative rotation between the sleeve 12 and the screw 11.

The bar material may be made of a magnesium alloy, an aluminum alloy, a copper alloy, or the like, a diameter of the bar material ranges from 3 mm to 8 mm, and a length of the bar material ranges from 200 mm to 4,000 mm.

A diameter of the screw ranges from 4 mm to 40 mm, a length of the stirring pin ranges from 0.3 mm to 5 mm, a screw flight depth ranges from 1 mm to 5 mm, and a pitch ranges from 10 mm to 30 mm.

The number of screw flights on the screw may be 1 to 3, and increasing the number of flights may enhance the shearing efficiency of the screw; and the number of stirring pins at a screw bottom may be 1 to 3, and increasing the number may improve a mixing degree of the deposited material and a substrate.

Step 2, a screw clamping portion 112 of the screw 11 is mounted on a rotating shoulder tool holder 41 of a friction stir welding machine, the sleeve 12 is mounted on a stationary shoulder bracket 42, and mounting positions are adjusted to ensure that a certain gap exists between an inner wall of the sleeve 12 and a side wall of the screw 11 and prevent contact and wear during rotation. Moreover, a sleeve bottom surface 121 and a bottom surface of the screw 11 should lie in the same horizontal plane, and the stirring pin 110 fully extends to ensure that the stirring pin acts sufficiently on the extruded material, which is conducive to enhancing metallurgical bonding between layers.

Step 3, suitable bar feeding wheels 24 are selected according to the bar material dimensions, and a gap between the upper and lower bar feeding wheels 24 (material feeding wheels) is adjusted by spring compression structures 26 to prevent slippage of the bar material in the feeding process; a bar feeding mechanism 2 is mounted and commissioned to ensure normal operation, a distance and an angle of inclination between the bar feeding mechanism and a welding machine spindle are adjusted such that the bar material reaches a feeding hole of the sleeve along a straight line after passing through the bar feeding wheels and limiting tubes, and the limiting tube on an output side is inserted into the feeding hole of the sleeve.

The bar feeding wheels in the bar feeding mechanism employ a V-groove design, and are configured to achieve automatic centering of the bar material, with a taper angle ranging from 10° to 45°, and fine recesses are etched in a contact surface of each bar feeding wheel with the bar material to increase a friction coefficient therebetween and prevent slippage in the bar feeding process.

Step 4, a material loading mechanism 3 is mounted and commissioned such that the bottommost bar material may fall from the magazine into a V-groove 31, a position of a photoelectric sensor 37 is adjusted such that a moment the sensor controls a cylinder 36 to extend coincides precisely with a moment the bar material is completely conveyed out of a magazine range, and the next bar material may fall down smoothly; and the material loading mechanism 3 is mounted onto brackets, the same angle of inclination as the bar feeding mechanism 2 and a certain mounting height are maintained, such that the bar material in the V-groove 31 is capable of entering the limiting tube 25 of the bar feeder through the limiting hole 38.

To prevent interference between the device and a workpiece in a height direction in an additive process, bar feeding angles of the designed bar feeding mechanism 2 and material loading mechanism 3 are adjustable within a range of 0° to 30°.

A stroke of the cylinder 36 in the material loading mechanism 3 should be less than the length of the bar material. The function of the cylinder 36 driving a push block 35 to convey the bar material is only to feed the bar material between the bar feeding wheels, and then the bar feeder continues completing the conveying task. Therefore, a distance between the limiting hole 38 and the bar feeding wheels 24 should be 50 mm to 400 mm, and the stroke of the cylinder 36 should be 100 mm to 500 mm.

The position of the photoelectric sensor in the material loading mechanism 3 may be adjusted through a sensor bracket. A distance between the sensor and a right side wall of the magazine should be 0 mm to 50 mm to ensure that the cylinder-driven push block and the currently conveyed bar material move out of the magazine range synchronously, such that the next bar material may fall smoothly into the V-groove, and the loading process is continued.

Step 5, a rational additive path is designed according to a shape of the additively manufactured component, and appropriate process parameters are selected; a substrate is mounted on a workpiece platform and clamped using fixtures, a coordinate origin is set, an additive program is written, and additive deposition is prepared.

A rotational speed range should be 50 rpm to 3,000 rpm, a travel rate should be 50 mm/min to 2,000 mm/min, a layer height should be 0.2 mm to 6 mm, a bar feeding rate should be 100 mm/min to 10,000 mm/min, and a deposition efficiency may reach 0.5 kg/h to 60 kg/h.

Step 6, in the additive process, first, the screw 11 rotates at a high speed, and the stirring pin 110 at the bottom plunges into the substrate. After reaching a predetermined depth, the bar feeding mechanism 2 is activated. The bar material is fed into the additive mechanism through the feeding hole, and is sheared by the screw into block-shaped particles, and the particles are conveyed to a bottom of the device through a helical cavity, and are extruded therefrom. Initially, the device generates less heat, and the material is difficult to fully plasticize, such that the particles remain in a granular state. As a volume of extruded particles increases, a gap between the screw bottom and the substrate is gradually filled, friction between the screw bottom and the particles generates heat, such that the particles deform and are gradually plasticized. At this moment, the feeding mechanism of the welding machine is activated, the plasticized particles are continuously extruded from the bottom of the device, are mixed with a substrate material under a stirring action of the stirring pin, and are deposited onto the substrate. As the additive process proceeds, temperatures at the bottoms of the screw and the sleeve 12 gradually increase, leading to thermal accumulation; and plastification of the particles occurs earlier in the helical cavity, and gradually reaches a steady state, such that the additive process proceeds stably.

Step 7, when the additive device completes a path for one layer and needs to proceed to the next layer, the screw 11 and the sleeve 12 are raised upward by a distance equal to one layer height, and then feeding continues; and at this moment, the additive process continues stably on the previously deposited layer.

Step 8, upon completion of the additive process, the screw 11 and the sleeve 12 are raised upward, and simultaneously the material loading mechanism 3 and the bar feeding mechanism 2 are deactivated; and the screw 11 is kept rotating until the remaining material in the helical cavity is extruded, and then the screw 11 is stopped to obtain the additively manufactured component that meets the requirements.

The present disclosure can solve the problems of FSAM technologies in the prior art, such as a difficulty in continuous material feeding, low deposition efficiency, and narrow material applicability, and simultaneously enables high-efficiency, high-quality additive manufacturing of large magnesium alloy and aluminum alloy components.

It should be noted that in the above embodiments, all technical solutions that are not contradictory may be combined. Those skilled in the art may exhaustively enumerate all possibilities according to mathematical knowledge of combinations, and therefore, the present disclosure does not describe each combined technical solution individually, but it should be understood that the combined technical solutions are already disclosed by the present disclosure.

The above descriptions are only preferred embodiments of the present disclosure and are not intended to limit the present disclosure. For those skilled in the art, various changes and modifications may be made to the present disclosure. Any modification, equivalent substitution or improvement within the spirit and principle of the present disclosure should fall within the protection scope of the present disclosure.

What is claimed is:

1. An off-axis bar feeding and coaxial deposition friction stir additive manufacturing (FSAM) device, comprising an additive mechanism, a bar feeding mechanism, a material loading mechanism, and a support mechanism, wherein the bar feeding mechanism and the material loading mechanism are both connected to the additive mechanism through the support mechanism;
the additive mechanism comprises a screw and a sleeve, wherein the screw is located in the sleeve, and the screw is coaxially arranged with the sleeve;
an upper portion of the screw is a screw clamping portion, a helical groove is machined on a side surface of a lower portion of the screw, and a stirring pin is machined at a bottom end of the screw;
an upper side of the sleeve is a sleeve clamping portion, a lower end of the sleeve is a sleeve bottom surface, a feeding hole is machined in a side surface of the sleeve, the helical groove of the screw is located in the sleeve, and the stirring pin extends from the lower end of the sleeve;
the support mechanism comprises a mounting disc, a rotating shoulder tool holder, a stationary shoulder bracket, a stationary shoulder bracket end cover, first bar feeder brackets, second bar feeder brackets, third bar feeder brackets, a channel steel crossbeam, aluminum profile brackets, and a tie rod, wherein the screw clamping portion of the screw is connected to the rotating shoulder tool holder, the sleeve clamping portion of the sleeve is located between the stationary shoulder bracket and the stationary shoulder bracket end cover, the rotating shoulder tool holder is rotatably connected coaxially to the mounting disc and the stationary shoulder bracket located above and below, and the mounting disc is relatively fixed to the stationary shoulder bracket; a front end of the bar feeder backplate is connected to the third bar feeder brackets through bolts, the two second bar feeder brackets are symmetrically arranged on outer sides of the third bar feeder brackets, an upper end of each second bar feeder bracket is connected to the corresponding first bar feeder bracket, and a rear end of each first bar feeder bracket is fixedly connected to the mounting disc; a first rectangular hole is machined in each first bar feeder bracket, two parallel second rectangular mounting holes are machined in each second bar feeder bracket, a threaded hole is machined in a top end of each second bar feeder bracket, and a third rectangular mounting hole is machined in each third bar feeder bracket; the third bar feeder brackets are adjusted to a suitable position, third bolts are passed through the second rectangular mounting holes and the third rectangular mounting holes and tightened with third nuts to fix the third bar feeder brackets and the second bar feeder brackets, and second bolts are passed through the first rectangular holes and connected to the threaded holes of the second bar feeder brackets to fix the second bar feeder brackets to the first bar feeder brackets; and the channel steel crossbeam is connected to a backplate of the material loading mechanism through a plurality of the aluminum profile brackets, a rear portion of the channel steel crossbeam is rotatably connected to the first bar feeder bracket, and both ends of the tie rod arranged obliquely are hinged to a middle portion of the channel steel crossbeam and an upper portion of the mounting disc, respectively; and
the tie rod comprises hinge seats, tie rod arms, and a connecting stud, wherein both ends of the connecting stud are threadedly connected to one end of each tie rod arm, respectively, each hinge seat is disposed at the other end of each tie rod arm, the two hinge seats are detachably connected to the channel steel crossbeam and the mounting disc through bolts, respectively.

2. The off-axis bar feeding and coaxial deposition FSAM device according to claim 1, wherein the bar feeding mechanism comprises a stepper motor, the bar feeder backplate, a motor gear, bar feeding wheel gears, bar feeding wheels, limiting tubes, and spring compression structures, wherein the motor gear and the bar feeding wheel gears on a side are mounted on the bar feeder backplate, the stepper motor is mounted on the bar feeder backplate, the motor gear is connected to an output end of the stepper motor, the motor gear meshes with the bar feeding wheel gears on one side, the bar feeding wheel gears on the other side are connected to the spring compression structures, the bar feeding wheel gears on both sides mesh with each other to form a bar feeding gear set, the bar feeding wheel gears are coaxially connected to the bar feeding wheels, the spring compression structures are connected to the bar feeder backplate, and the limiting tubes are disposed at front and rear ends of the bar feeder backplate.

3. The off-axis bar feeding and coaxial deposition FSAM device according to claim 2, wherein the bar feeding mechanism further comprises bolts, wherein the bar feeding wheel gears and the bar feeding wheels are connected by the bolts, the two bar feeding wheels are arranged correspondingly, the two bar feeding gear sets are arranged on both sides of the motor gear, the limiting tubes are arranged on both sides of the two bar feeding gear sets, and the limiting tube on an output side is arranged corresponding to the feeding hole;
the bar feeding mechanism further comprises limiting tube brackets, each limiting tube is provided with a bell mouth, the limiting tubes are detachably connected to the bar feeding mechanism through the limiting tube brackets, and the limiting tubes are arranged corresponding to a position between the two bar feeding wheels; a V-groove matching a diameter of a bar material is machined in a middle portion of a side surface of each bar feeding wheel, and configured to achieve automatic centering of the rod material between the two bar feeding wheels; and wheel side recesses are laser-etched in a side surface of each bar feeding wheel, and configured to increase a friction between the bar feeding wheel and the rod material and prevent slippage in a bar feeding process; and
each spring compression structure comprises a compression frame, a spring, a compression nut, and a slide rod, wherein the two compression frames are hinged at one end, and each compression frame is provided with a U-shaped slide groove at the other end; the T-shaped slide rod is fixed to the bar feeder backplate, a vertical segment of the slide rod is connected to the bar feeder backplate, the spring is sleeved over a horizontal segment of the slide rod, and an end of the horizontal segment of the slide rod is threadedly connected to the compression nut; and the horizontal segment of the slide rod is disposed in the U-shaped slide groove of the compression frame, the U-shaped slide groove of the compression frame is located between the vertical segment of the slide rod and the spring, and the bar feeding wheel gear and the corresponding bar feeding wheel on the other side are connected to a middle portion of the compression frame.

4. The off-axis bar feeding and coaxial deposition FSAM device according to claim 1, wherein the material loading mechanism comprises the backplate, a V-groove, cover plates, a base plate, a guide shaft, a push block, a cylinder, a photoelectric sensor, and a limiting hole, wherein the cover plates are mounted on both sides of the backplate, the base plate is mounted at a lower portion of the backplate, and the V-groove and the cylinder are mounted on the base plate; and the guide shaft is mounted on a front side of the base plate, and the photoelectric sensor and the limiting hole arranged front-to-back are mounted on a rear side of the base plate; and an output end of the cylinder is connected to the push block, the push block is slidably connected to the guide shaft, an end of the push block cooperates with the V-groove, and the cylinder is electrically connected to the photoelectric sensor.

5. The off-axis bar feeding and coaxial deposition FSAM device according to claim 3, wherein the material loading mechanism further comprises guide shaft brackets and a cylinder rod, wherein the cylinder is connected to the push block through the cylinder rod, and both ends of the guide shaft are connected to the base plate through the guide shaft brackets; and
the photoelectric sensor comprises a sensor bracket, a transmitter, and a receiver, a sensor bracket mounting hole is machined in the base plate, and a light transmission hole is machined in the backplate; the sensor bracket is M-shaped, a screw rod and nuts are disposed on a middle vertical plate of the sensor bracket, the screw rod passes through the sensor bracket mounting hole, and after a position of the screw rod is adjusted, the nuts on both sides of the screw rod are tightened to clamp the base plate, so as to fix the sensor bracket; a vertical plate of the sensor bracket on one side is located on a left side of the light transmission hole, the receiver is mounted on the vertical plate of the sensor bracket on one side, a vertical plate of the sensor bracket on the other side is located on a right side of the light transmission hole, and the transmitter is mounted on the vertical plate of the sensor bracket on the other side; and the limiting tube on an input side is arranged corresponding to the limiting hole.

6. An off-axis bar feeding and coaxial deposition FSAM method, employing the off-axis bar feeding and coaxial deposition FSAM device according to claim 1, and comprising the following steps:
positions of a bar feeding mechanism and a material loading mechanism are adjusted through a support mechanism to adapt to an additive mechanism;
to-be-conveyed bar materials are arranged individually along a vertical direction, the bottommost to-be-conveyed bar material is discharged downward by gravity to become a currently conveyed bar material, and the currently conveyed bar material rests on a V-groove;
a photoelectric sensor detects the currently conveyed bar material, a cylinder rod is controlled to retract, and a push block is driven to push a front end of the currently conveyed bar material into a limiting tube on one side through a limiting hole along the V-groove;
the front end of the currently conveyed bar material is conveyed between bar feeding wheels, a motor gear drives bar feeding wheel gears on one side, and the bar feeding wheel gears on one side in turn drive bar feeding wheel gears and bar feeding wheels on the other side to rotate, such that the currently conveyed bar material is conveyed into a limiting tube on the other side; after a rear end of the currently conveyed bar material moves away from the photoelectric sensor, the photoelectric sensor controls the cylinder rod to extend, and the push block is driven to return; after the push block returns to an initial position, the next to-be-conveyed bar material, no longer obstructed by the push rod, descends by gravity into the V-groove, and the photoelectric sensor detects the subsequent currently conveyed bar material, and the material conveying process continues; and
the front end of the currently conveyed bar material is conveyed into the additive mechanism through a feeding hole, is sheared and plasticized, and is then extruded from a lower portion of a sleeve onto a substrate, a stirring pin stirs the material, and a sleeve bottom surface levels the material, such that the additive manufacturing process is completed.
